(19) United States
(12) Patent Application Publication
(10) Pub. No.: US 2007/0006925 A1
(43) Pub. Date: Jan. 11, 2007

(54) Washer fluid reservoir having a fluid-impermeable air vent patch

(76) Inventors: Jennifer E. Toscano, Fort Wayne, IN (US); Steven R. Siler, Fort Wayne, IN (US); Matthew M. Sullivan, St. Joe, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/175,661

(22) Filed: Jul. 6, 2005

(51) Int. Cl. F16K 24/00

(52) U.S. Cl. 137/587

(57) ABSTRACT

A washer fluid system (20) in a motor vehicle (10). A walled reservoir (22) holds washer fluid used to wash one or more windows (16) of the vehicle. Washer fluid is introduced through a fill opening (26) to fill the reservoir. The reservoir has one or more through-openings (36, 38, 40, 42) in a wall (44) at a location suitable for venting air from the reservoir during filling. One or more fluid-impermeable, air-permeable elements (46, 48) close the one or more through-openings. The elements are patches adhered to the reservoir wall in covering relation to the through-openings. Venting through such an element can eliminate the vent tube or neck used in prior washer fluid systems and enable more complete filling of a reservoir.

### FIELD OF THE INVENTION

This invention relates generally to fluid reservoirs that are refilled from time to time to replenish their contents after fluid has been withdrawn. The invention further relates to a novel washer fluid reservoir and arrangement of such a reservoir in a motor vehicle where the reservoir holds a supply of washer fluid that is used in association with motor-operated wipers for washing and wiping certain windows such as a windshield of the vehicle.

### BACKGROUND OF THE INVENTION

Washer fluid reservoirs, sometimes called washer fluid bottles, are installed in motor vehicles to hold an on-board supply of washer fluid, sometimes called windshield washer fluid. When a washer fluid reservoir holds washer fluid that is used to wash a windshield of a motor vehicle, the reservoir is often located in or near the engine compartment. A washer fluid reservoir has a fill opening that is typically closed by a removable cap and that when uncapped, provides access for pouring fresh fluid into the reservoir to replenish the supply of washer fluid. Depending on the specific placement of a washer fluid reservoir in a particular motor vehicle, a fill tube or fill neck extending generally upward from the interior of the reservoir to the fill opening may be necessary to enable the reservoir to be conveniently filled.

Washer fluid is typically poured from a container into the uncapped fill opening to fall under force of gravity into the reservoir. As a reservoir is being filled, the washer fluid displaces air from the interior of the reservoir. As long as the transverse cross section of the fill opening, including that of any fill neck or fill tube that may be present, is sufficiently large, the air being displaced can vent through the fill opening, passing in the opposite direction from the fluid being poured into the reservoir without seriously impeding the fluid flow.

If that is not the case, a separate vent opening may be needed. Hence certain washer fluid reservoirs have both a fill port and a vent port at the reservoir wall.

When such a reservoir is disposed at an elevation well below the point at which it is convenient to fill it, a fill tube, or neck, extends from the fill port generally upward, and possibly tortuously, ending at the capped fill opening. In order to fill the reservoir to the maximum, the best place on the reservoir to locate the fill port is at the highest elevation of the reservoir. But such a location may not always be available because of space limitations in a vehicle which may influence where the fill port can be located. The location of the vent port may also affect the extent to which a reservoir can be filled.

If fluid in such a reservoir reaches a level that blocks the venting of air through the vent port, and unfilled headspace remains in the reservoir interior, air in that headspace becomes trapped and cannot escape, thus limiting the extent to which the reservoir can be filled with fluid. When it is possible for fluid to reach the elevation of the vent port, the issue of possible escape of fluid through the vent port must also be addressed. One way to do so is to provide a vent tube or neck running generally upward, and possibly tortuously, from the vent port. Such a vent tube or neck serves a further purpose aside from containing fluid that passes through the vent port.

Washer fluid systems typically rely on visual observation by a person filling a reservoir to ascertain when the reservoir has been filled. In a system where venting occurs through the fill opening, an attentive person will be able to see when the fluid level is approaching the point where the reservoir is essentially full and will therefore stop the filling. When venting of the reservoir is through a separate vent port at the reservoir wall and continuing through a tube, or neck, running upward from the vent port to the vent opening, the upper terminus of the tube or neck that forms the vent opening should be at substantially the same elevation as that of the fill opening in order to enable the person to see the rising fluid approaching the fill opening as fluid escaping through the vent port is seeking the same level in the vent tube or neck. Hence the vent tube or neck both avoids spillage of fluid and enables the completion of reservoir filling to be visually observed at the fill opening.

### SUMMARY OF THE INVENTION

The present invention relates to a novel washer fluid reservoir and arrangement of such a reservoir in a motor vehicle.

The invention eliminates the need for a vent tube running generally upward from a vent port at the reservoir wall to end at a vent opening at substantially the same elevation as the fill opening. It is believed that this provides motor vehicle designers with greater freedom in locating a washer fluid reservoir in a motor vehicle, especially in and near an engine compartment where space is often at a premium, because the reservoir can be located in a space where no consideration need be given as to how a vent tube is to be routed from the reservoir to place the vent opening at the tube's opposite end at substantially the same elevation as the fill opening. Moreover, the cost of the vent tube is not incurred.

By enabling a reservoir of given size and shape to be vented at its point of highest elevation without a vent tube, the invention may enable the reservoir to be filled with a greater volume of fluid than would otherwise be possible if a vent tube could not be connected to the reservoir at the highest elevation due to dimensional interference of the vent tube (or of a vent port at the reservoir wall to which the vent tube is fit) with other structure or structures in the surrounding vicinity.

Accordingly, one generic aspect of the present invention relates to a washer fluid system in a motor vehicle having a motor-operated wiper that wipes a window of the vehicle onto which the washer fluid system dispenses washer fluid. The system comprises a walled reservoir for holding washer fluid, a fill opening through which fluid is introduced to fill the reservoir, a through-opening in the reservoir wall at a location suitable for venting air from the reservoir during filling, and a fluid-impermeable, air-permeable element closing the opening.

A further generic aspect of the invention relates to a walled reservoir for holding fluid, a fill opening through which fluid is introduced to fill the reservoir, a through-opening in the reservoir wall at a location suitable for venting air from the reservoir during filling, and a fluid-impermeable, air-permeable element closing the opening.

The foregoing, along with further features, advantages, and aspects of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a side elevation view of a portion of motor vehicle, with portions broken away for the purpose of illustration, to show a washer fluid reservoir installation in accordance with principles of the present invention.

FIG. 2 is a larger side elevation view of the reservoir of FIG. 1 shown by itself.

FIG. 3 is a top plan view of FIG. 2.

FIG. 4 is a fragmentary view in the same direction as FIG. 3 showing another embodiment.

FIG. 5 is a fragmentary view in the same direction as FIG. 3 showing another embodiment.

FIG. 6 is a fragmentary view in the same direction as FIG. 3 showing another embodiment.

### DESCRIPTION OF THE PREFERRED EMBODIMENTS

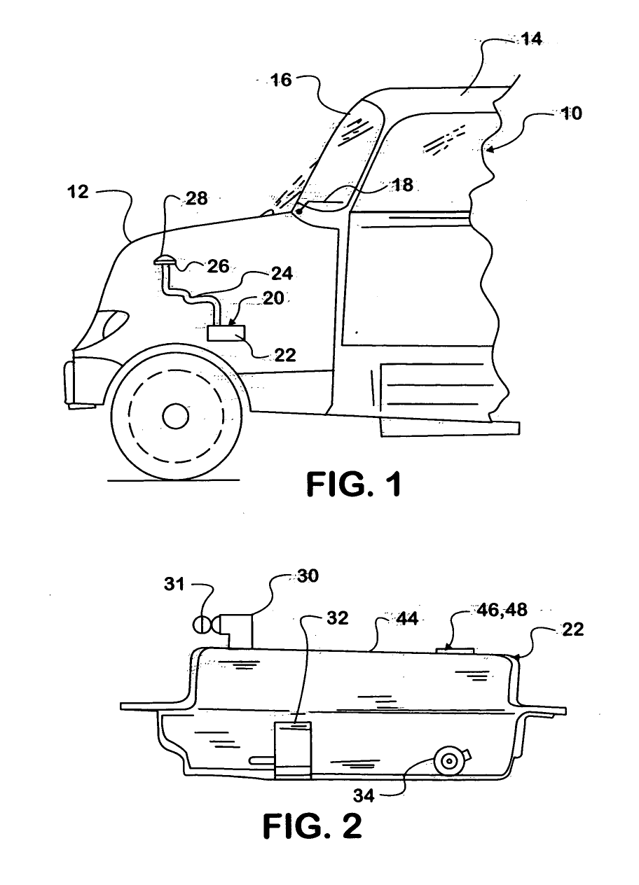

FIG. 1 shows a motor vehicle such as a large truck 10 having a front engine compartment 12 ahead of a cab 14. Cab 14 has a glass windshield 16 and motor-operated wipers 18 for wiping the exterior of windshield 16.

Associated with wipers 18 is a washer system 20 for dispensing washer fluid onto the exterior of windshield 16. Washer system 20 comprises a walled reservoir 22 for holding a supply of washer fluid. A fill tube, or neck, 24 is disposed along a tortuous, but generally upward path from reservoir 22 to end at a fill opening 26 that is shown closed by a removable cap 28. When cap 28 is removed, washer fluid can be poured from a container into the uncapped fill opening 26 to fall under force of gravity through tube 24 into reservoir 22. As reservoir 22 is being filled, the washer fluid displaces air from the reservoir interior, and so venting of the reservoir is needed to allow filling to occur.

If venting can occur only through fill tube 24, and if the fill tube has a tortuous shape and/or is significantly restricted in cross section at any point along the path to the reservoir, the rate at which fresh washer fluid can fall through the fill tube and into the reservoir will be limited. Hence, separate venting is sometimes desirable in order to shorten the fill time.

Venting through a separate vent tube may not be a suitable solution in certain vehicles due to limited or unsuitable open space for routing the vent tube from the reservoir to an elevation that is substantially the same as that of the fill opening. The present invention provides a solution that is shown in detail by FIGS. 2-6.

FIG. 2 shows a generic, arbitrarily rectangular, shape for reservoir 22. Actual reservoirs are typically shaped to fit to available space in a vehicle so as to maximize their volumetric capacity. This is done by making reservoirs according to known fabrication processes such as by plastic molding of suitably appropriate material.

Reservoir 22 comprises an inlet port 30 that is ideally located substantially at the highest elevation of the reservoir. Inlet port 30 is shown to comprise a barbed nipple 31 over the free end of which one end of fill tube 24 is fit. For withdrawing washer fluid from the reservoir interior, an electric pump 32 is disposed with its inlet near the lowest elevation of the reservoir. When pump 32 operates, it pumps fluid through a conduit from the reservoir to one or more spray nozzles directed toward windshield 16 to spray the windshield exterior with fluid. A level sensor 34 also near the low point in the reservoir serves to signal a warning when the fluid level in the reservoir drops to a point when there is an imminent need for refilling.

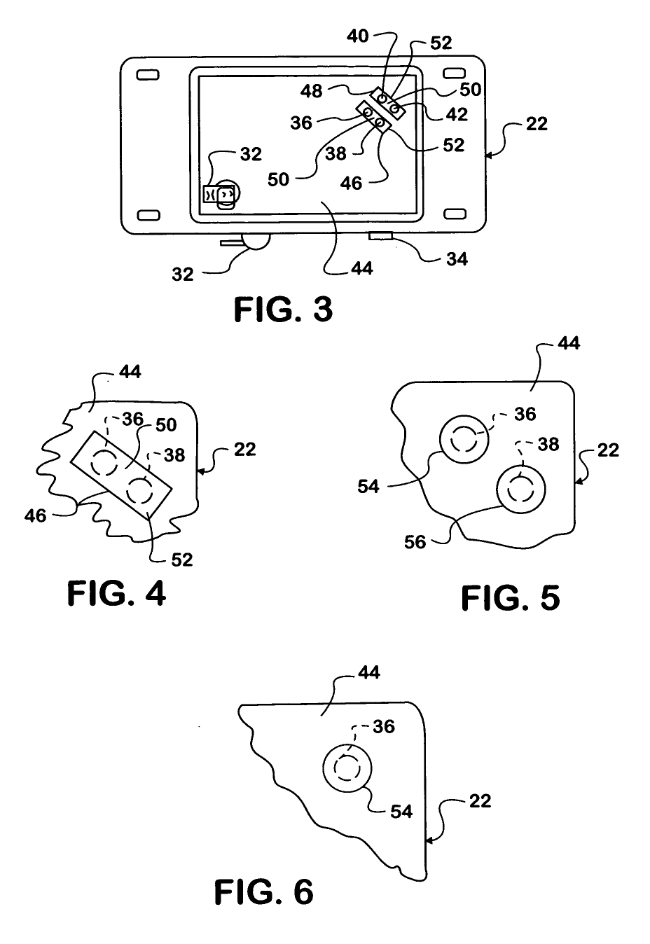

In accordance with the present invention, venting of reservoir headspace occurs through one or more through-openings in the wall of the reservoir. The embodiment of FIG. 3 comprises four such through-openings 36, 38, 40, 42 in the top wall 44 of reservoir 22. Each opening is circular in shape, with the four openings arranged in a pattern such that each of two pairs can be covered by a respective overlying rectangular patch 46, 48, as shown. Each patch 46, 48 comprises a central fluid-impermeable, air-permeable zone 50 covering the respective pair of through-openings. The perimeter margin 52 of each patch beyond zone 50 is joined to the external surface of wall 44 surrounding the respective through-hole pair to create a fluid-tight seal of margin 52 to wall 44. Any suitable means of joining can be used, such as a suitable adhesive carefully applied to form, when cured, a durable continuous seal.

In this way the headspace of reservoir 22 is continually vented to the outside atmosphere through the through-openings and the overlying air-permeable zones 50. Yet, fluid cannot leak through because zones 50 are impermeable to washer fluid and the margins of the patches are sealed fluid-tight to the reservoir wall.

Patches 46, 48 are representative of adhesive vents sold under the trademark OLEOGARD® by W. L. Gore & Associates, Inc. Such vents are a laminate that comprises a microporous membrane bonded to a durable woven backer with high performance pressure sensitive adhesive providing the means of attachment to a reservoir.

FIG. 4 shows an embodiment where there is only a single pair of circular through-openings 36, 38 covered by a single rectangular patch 46.

FIG. 5 shows an embodiment where there is only a single pair of circular through-openings 36, 38 each covered by a respective circular patch 54, 56.

FIG. 6 shows an embodiment where there is only a single circular through-opening 36 covered by a circular patch 54.

The number, the locations, and the sizes of the through-openings, in conjunction with the air-permeability characteristic of the overlying patch, determine the rate at which air is vented from the reservoir as fresh fluid is being poured into the reservoir, and hence how quickly the reservoir can be filled. The patches obviously present some resistance to venting, but by judicious selection of the number, the locations, and the sizes of the through-openings, fill time can be made what is considered to be reasonable, although possibly not quite as fast as with an open vent tube.

The advantages afforded by the invention are considered to outweigh what may be a modestly longer fill time when compared to use of an open vent tube for venting. The invention offers the possibility of maximizing the volumetric capacity of a reservoir because there is no need for clearance to accommodate a vent tube, and for a given volumetric capacity and shape, it may be possible to more completely fill a reservoir where a patch or patches are on the top wall when compared to a reservoir where a vent port is near, but not at the highest point in the reservoir. Greater flexibility in placement of the reservoir also become possible because considerations relevant to accommodating a vent tube do not apply because there is no vent tube.

While a presently preferred embodiment of the invention has been illustrated and described, it should be appreciated that principles of the invention apply to all embodiments falling within the scope of the following claims.

What is claimed is:

1. A washer fluid system in a motor vehicle having a motor-operated wiper that wipes a window of the vehicle onto which the washer fluid system dispenses washer fluid, the system comprising:
a walled reservoir for holding washer fluid, a fill opening through which fluid is introduced to fill the reservoir, a through-opening in the reservoir wall at a location suitable for venting air from the reservoir during filling, and a fluid-impermeable, air-permeable element closing the opening.

2. A washer fluid system as set forth in claim 1 wherein the through-opening is disposed in a generally horizontal wall portion of the walled reservoir substantially at the highest elevation of the walled reservoir.

3. A washer fluid system as set forth in claim 2 wherein the walled reservoir comprises a fill port at which fluid is introduced into the reservoir and which is disposed substantially at the highest elevation of the walled reservoir.

4. A washer fluid system as set forth in claim 3 including a fill tube running upward from the fill port to terminate at a fill opening disposed at an elevation higher than the highest elevation of the walled reservoir where fluid can be poured into the fill tube to fill the reservoir.

5. A washer fluid system as set forth in claim 4 including a cap disposed on the fill tube removably closing the fill opening.

6. A washer fluid system as set forth in claim 1 wherein the fluid-impermeable, air-permeable element comprises a patch adhered to the exterior of the walled reservoir to covering relation to the through-opening.

7. A washer fluid system as set forth in claim 1 wherein the through-opening comprises a pattern of multiple discrete through-openings, and the fluid-impermeable, air-permeable element comprises a patch adhered to the exterior of the walled reservoir to covering relation to the pattern of multiple openings.

8. A washer fluid system as set forth in claim 1 wherein the through-opening comprises a pattern of multiple discrete through-openings, and the fluid-impermeable, air-permeable element comprises multiple discrete patches each adhered to the exterior of the walled reservoir in covering relation a respective one of the multiple discrete openings.

9. A walled reservoir for holding fluid, a fill opening through which fluid is introduced to fill the reservoir, a through-opening in the reservoir wall at a location suitable for venting air from the reservoir during filling, and a fluid-impermeable, air-permeable element closing the opening.

10. A walled reservoir as set forth in claim 9 wherein the through-opening is disposed in a generally horizontal portion of a top wall of the reservoir.

11. A walled reservoir as set forth in claim 10 wherein the fluid-impermeable, air-permeable element comprises a vent patch adhesively attached to the exterior of the generally horizontal portion of the top wall in covering relation to the through-opening.

12. A walled reservoir as set forth in claim 11 wherein the through-opening comprises a pattern of multiple discrete through-openings, and the vent patch is disposed in covering relation to the pattern of multiple openings.

13. A walled reservoir as set forth in claim 11 wherein the through-opening comprises a pattern of multiple discrete through-openings, and multiple discrete vent patches are each adhered to the exterior of the walled reservoir in covering relation a respective one of the multiple discrete openings.
